(19) United States
(12) Patent Application Publication
(10) Pub. No.: US 2025/0222554 A1
(43) Pub. Date: Jul. 10, 2025

(54) Retainer for the Processing of Optical Workpieces, in Particular Eyeglass Lenses

(71) Applicant: Satisloh AG, Baar (CH)

(72) Inventors: Holger Schäfer, Weilmünster (DE); Steffen Wallendorf, Wetzlar (DE); Tobias Gelada, Schöffengrund (DE); Johannes Claar, Ebsdorfergrund (DE)

(21) Appl. No.: 18/700,197

(22) PCT Filed: Oct. 16, 2022
(86) PCT No.: PCT/EP2022/078754

§ 371 Date: Apr. 10, 2024

(30) Foreign Application Priority Data
Oct. 19, 2021 (DE) 10 2021 005 202.1

(51) Int. Cl. B24B 13/005

(52) U.S. Cl. CPC B24B 13/005

(57) ABSTRACT

Disclosed is a retainer (10) for processing an optical workpiece. The retainer comprises a holding arrangement (72) and a support assembly (73) for the workpiece. A rubber-elastic membrane (75) mounted on a housing (74) has a retaining section (76), on the outer side (77) of which one surface of the workpiece can be placed to lie flat. The membrane, together with the housing defines a chamber (78) in which a plurality of separately longitudinally movable pins (79) of the support assembly are retained. A pin end (80) of each pin can be brought to bear against an inner side (81) of the retaining portion of the membrane and can be fixed relative to one another by a clamping mechanism (82) against longitudinal movement with respect to the housing. The holding arrangement for the workpiece is provided in or on the retaining section of the membrane.

### TECHNICAL FIELD

The present invention relates generally to a retainer for the processing of optical workpieces. In particular, the invention relates to a retainer for the processing of spectacle lenses, preferably spectacle lenses of plastic such as, for example, polycarbonate, CR39 or so-called “high index” materials, but in principle also for spectacle lenses of hard brittle materials such as, for example, mineral glass. Spectacle lenses of that kind are produced on a very large scale in so-called “RX workshops”, i.e. production facilities for production of individual spectacle lenses according to prescription.

The retainer described herein is very well suited to, for example, use in a method for (area) processing by machining of, in particular, spectacle lenses of plastic such as described in the earlier German patent application DE 10 2021 004 831.8 of the same applicant, to which express reference is made at this point with regard to method details.

### PRIOR ART

In the above-mentioned earlier German patent application there has already been express description of those process steps which currently are usually performed in RX workshops in the industrial production of spectacle lenses, so that the usual procedure need be only briefly outlined at this point. The starting product in industrial production of spectacle lenses is a semi-finished spectacle lens blank, also termed “blank”, which has one optically effective surface already processed to finished state and provided by injection molding or preshaped in some other way and which is to be processed at its other optically effective surface and at the edge between the optically effective surfaces to form a finished spectacle lens.

After protection of the pre-shaped optically effective surface by a protective film or a protective lacquer so-called “blocking” of the respective spectacle lens blank is carried out, which in that case is connected with a suitable so-called “block piece”, for example a block piece in accordance with German Standard DIN 58766. For the blocking, firstly position and optionally shape of the spectacle lens blank are determined by measurement before the spectacle lens blank is then positioned in six degrees of freedom relative to the block piece so that the block piece adopts a predetermined position relative to the protected, preshaped surface of the spectacle lens blank. Fixing of this set position takes place subsequently by filling the space between block piece and spectacle lens blank with a conventional molten material (“alloy” or wax; see, for example, document EP 1 593 458 A2) or alternatively by a suitable thermoplastic, thermosetting or elastomeric plastic or adhesive (see, for example, documents DE 10 2007 007 161 A1, EP 2 011 604 A1, WO 2009/135689 A1). After solidifying or hardening of the filler material the block piece represents a mount or machine interface for processing of the spectacle lens blank, which subsequently remains at the spectacle lens for several processing procedures in different machines so as to then be able to rotationally drive the spectacle lens and reliably hold it in an always defined position.

In the next process step, i.e. the so-called “generation”, the hitherto not yet processed optically effective surface of the respective spectacle lens blank gains its macrogeometry, i.e. optically active shape in accordance with prescription, in a special processing machine, also called “generator” (see, for example, documents EP 1 719 585 A2, EP 2 011 603 A1), by (preliminary) processing by machining; in the case of plastic this is usually milling and/or turning with a geometrically defined cutting edge. In that case the blocked spectacle lens blank is held by the block piece at a rotationally driven workpiece spindle. The generation usually comprises at least two sub-steps (see, for example, document EP 1 203 626 B1), namely preliminary edge processing, also called preliminary edging or “cribbing”, in which the edge of the spectacle lens blank is processed from the so-called “raw diameter” to the so-called “finished diameter”—in the case of plastic by, for example, a plate mill (cf., for example, document EP 0 758 571 B1)—and a surface processing subsequent thereto. In the case of plastic the latter can begin by a (at least one) milling cycle over the surface, in accordance with which the main quantity of the blank material to be removed is already taken away, usually followed by an “out-of-round” rotary processing with the help of a so-called “fast tool” arrangement (see, for example, document EP 1 779 967 A2) for the reciprocating drive of a diamond turning tool so as to (also) work non-rotationally symmetrical surface sections—for example freeform areas in varifocal lenses—at the semi-finished product. A precondition for the discussed preliminary edge processing by a mill is that the block piece temporarily mounted on the front side of the spectacle lens blank has a maximum diameter smaller than the finished diameter of the workpiece, since otherwise a collision between milling tool and block piece would occur.

Fine processing by (micro) machining, which is broadly termed “polishing”, of the spectacle lenses is then carried out, in which the pre-processed optically effective surface of the respective semi-finished product gains the desired microgeometry (surface quality), in particular by geometrically undefined cutting. For that purpose the blocked semi-finished product, which has been pre-processed by machining, is removed from the generator and further processed in a fine-processing or polishing machine (see, for example, document EP 2 308 644 A2). In that case, positioning and fixing of the semi-finished product in the polishing machine also take place by the block piece (see, for example, document EP 1 473 116 A1). During the polishing treatment there is movement—with addition of a liquid polishing agent provided with abrasive particles—by a flexible polishing tool or polishing plate (see, for example, documents EP 1 698 432 A2, WO 2016/058661 A1) in defined tracks over the pre-processed surface so as to reduce surface roughness.

Marking of the semi-finished product takes place as a next, optional process step, wherein, for example, two small circles are generated on the rear surface of the semi-finished product by, for example, a laser beam or mechanically by an engraving graver (see, for example, document EP 1 916 060 B1). This is necessary for, for example, freeform surfaces so as to reliably find, by way of the applied markings, the position of the semi-finished product in later processing steps. Since a high degree of accuracy in positioning is required here, positioning and fixing during marking also take place by way of the block piece.

The semi-finished product is separated from the block piece only after this processing. The so-called “deblocking” takes place, for example, in the case of the afore-mentioned adhesive connection by a high-pressure water jet which is delivered by a nozzle and which impinges on an edge location between block piece and semi-finished product in order to detach the semi-finished product from the block piece by application of hydraulic forces (see, for example, documents WO 2011/042091 A1, WO 2011/107227 A1). As a consequence, the processed semi-finished product is now present as a single item and the separated block piece is cleaned and returned to the process step of blocking.

In further processing, the semi-finished product after cleaning is optionally coated at its front side and/or rear side in order to achieve additional effects: increase in scratch resistance by hard-coating, anti-reflection properties, coloration, metallization, hydrophobic properties, etc.

In conclusion, so-called “edging” is performed as a final process step, in which the semi-finished product is processed again at the edge for fitting into a desired spectacles frame, so that it receives the shape of the respective spectacles rim. Since the semi-finished product is now no longer fixed on the block piece, the position has to be re-established here (for example by way of the afore-mentioned markings) before the semi-finished product can be suitably fixed and finally processed in a so-called “edger” as an edge processing device (see, for example, document EP 1 243 380 A2) with respect to its edge shape and fastening in the spectacles frame.

The process chain outlined in that regard from the prior art includes in the steps “blocking” and “deblocking” two sequences which represent necessary auxiliary processes, but do not themselves enhance the value of the produced spectacle lens. A process chain managing without these auxiliary processes would thus be desirable. In particular, in order to increase efficiency and also for ecological considerations it has already been proposed in the prior art to operate “blocklessly” in the production of optically effective surfaces of spectacle lenses (see, for example, documents WO 2015/059007 A1, U.S. Pat. No. 9,969,051 B2, DE 10 2016 112 999 A1 and DE 10 2004 016 445 B4).

In this connection, document WO 2015/059007 A1 discloses a method for block-free surface processing of spectacle lenses which in that case are held (inter alia) by vacuum. In this prior art a feature is that the lens during surface processing is held in “two stages”: If the cutting tool in the form of a turning tool or mill has surface-processing engagement in the region of the lens edge with a large lever action, retention of the lens is carried out at the front surface by application of a vacuum at a suction chamber, which is sealed relative to the front surface of the lens by an encircling seal, and a central counter-holder in the form of a rotating die at the rear surface, thus from both sides. When the surface processing then progresses and, with lower processing forces, approaches the lens center the central counter-holder is retracted and the lens is held solely by the vacuum. The lens edge is mentioned as a possible (alternative) holding surface for the surface processing.

A problem with this prior art is to be seen in the fact that, in particular, the lens is placed in “hollow” manner on the seal surrounding the central suction chamber. In the case of comparatively thin lenses there is thus specifically a risk of the lens experiencing elastic deformation or deflection as a consequence of the retention forces applied by the central counter-holder or the centrally acting processing forces. This can lead during processing to unacceptable differences between the actual geometry produced at the rear surface and the target geometry desired thereat, which become noticeable when the lens after processing “relaxes” again. Such lens deformations detracting from processing quality and caused by the retention system are particularly critical when comparatively complex surface geometries (i.e. other than purely spherical or toroidal surfaces) are to be produced.

In fact, in this prior art there is also shown and described an embodiment (FIG. 3) which in the suction chamber has a plurality of concentrically arranged, individually axially movable rings, which are resiliently biased in the direction of the lens to be held, for support. However, if the lens to be held has a non-rotationally symmetrical geometry at its surface to be retained, local cavities together with the above-discussed risk of undesired deformation of the lens under the acting processing forces in these unsupported cavities arise anyway between the lens and the rings.

A differently constructed holder for pneumatic blocking or retention of optical lenses at a surface processing machine is disclosed in document U.S. Pat. No. 9,969,051 B2. The prior art holder firstly comprises a clamping part for securing to an associated component of the surface processing machine. Further, this holder has a subassembly for blocking the lens, the subassembly comprising a base body from which project abutments intended to offer the lens a firm seat, as well as a seal with which the lens can be brought into contact so as to bound a vacuum chamber together with the base body. The abutments comprise a plurality of first rods which are mounted to be displaceable with respect to the base body so as to be supported at the lens by their free ends and three second rods fixedly connected with the base body. In addition, restoring elements in the form of springs are provided at the first rods so as to reset, i.e. lay, the first rods against the lens.

In this prior art the rods provided in the region of the vacuum chamber thus also produce—radially within the seal—axial support at the front surface of the optical lens, which is sucked against the mount, when processing forces act on the rear surface of the lens during machining of the lens. However, here as well comparatively large cavities, which are elastically bridged over by the lens, are present between the individual rods, which in turn involves a risk of undesired deformation of the lens under the acting processing forces and the prevailing holding vacuum in the lens regions without direct axial support.

In addition, document DE 10 2016 112 999 A1 is concerned with the design of a workpiece mount for the mounting of optical lenses in lens processing machines, which is to enable block-free clamping of the lens during surface processing. The workpiece mount disclosed therein is also constructed for different “clamping techniques”. On the one hand, for suction of the lens against a mount surface of an insert formed from a porous material a sub-atmospheric pressure can be applied by way of an air channel, whereupon the lens can be (finely) processed with moderate forces (turning, grinding, polishing). On the other hand, the lens can be clamped at its round circumferential edge and, in particular, by mechanical clamping fast by clamping regions provided at a clamping chuck, which shall make “more powerful” (preliminary) processing (milling, turning) possible.

However, in this prior art there is also the risk of lens deformations detracting from processing quality when the lens is mechanically clamped at the circumferential edge by radially acting clamping forces.

Finally, the same applies—i.e. the risk of undesired workpiece deformations as a consequence of radially directed clamping forces—to the mounting chuck, which is disclosed in the document DE 10 2004 016 445 B4, for block-free holding of spectacle lenses and other shaped bodies with optically effective surfaces during processing. According to this prior art (see paragraph 3 thereof), which forms the preamble of claim 1, the mounting chuck broadly comprises as holding arrangement a collet chuck with radially displaceable clamping jaws for engagement with the edge of the spectacle lens blank to be processed as well as, in the center, a flexible support device which has a rubber-elastic upper membrane mounted on a housing.

The upper membrane has a retaining section, on the outer side of which the spectacle lens blank can be placed over an area by its optically effective surfaces. In addition, in the housing the upper membrane bounds a chamber in which a plurality of separate longitudinally displaceable cylindrical pins of the support device is received. The cylindrical pins circumferentially gripped in a hollow-cylindrical section of the upper membrane can each be laid by a pin end against an inner side of the retaining section of the upper membrane. For that purpose the cylindrical pins project on the side thereof, which is remote from the retaining section of the upper membrane, by their other pin ends out of the hollow-cylindrical section of the upper membrane in the direction of a widening in the housing, where they are supported by a discoid rubber-elastic lower membrane.

The widening in the housing can be acted on by compressed air, wherein the cylinder pins are urged by way of the lower membrane in the direction of the retaining section of the upper membrane so that they hit against the upper membrane and urge this against the laid-on spectacle lens blank. In order to now firmly support the retaining section of the upper membrane in accordance with a geometry of the spectacle lens blank held by the holding arrangement the cylindrical pins can be selectively fixed against longitudinal displacement relative to one another and, in particular, by an annular rubber sleeve, which is placed around the hollow-cylindrical section of the upper membrane and which can also be acted on by compressed air, so as to effect pin clamping in transverse direction.

### Object

By comparison with the prior art outlined to that extent the invention has the object of providing, particularly for a production process chain ideally managing entirely without blocking, a retainer for the processing of optical workpieces, namely spectacle lenses, which generally addresses the problems described above with respect to the prior art and which is specifically capable of holding and supporting a workpiece in reliable—in terms of process—manner during workpiece processing and without workpiece deformations detracting from processing quality.

### Illustration of the Invention

This object is fulfilled by a retainer for the processing of optical workpieces, particularly spectacle lenses, with the features of claim 1. Advantageous or expedient embodiments and developments of the invention are the subject of the dependent claims.

According to the invention, in a retainer for the processing of optical workpieces, particularly spectacle lenses which each have two workpiece surfaces and a workpiece edge therebetween—the retainer comprising a holding arrangement for a workpiece to be processed as well as a support arrangement therefor having a rubber-elastic membrane, which is mounted on a housing and has a retaining section, on the outer side of which the workpiece can be laid over an area by one of the workpiece surfaces thereof, and which together with the housing bounds a chamber in which a plurality of separate longitudinally displaceable pins of the support arrangement is received, which pins can be respectively brought into contact with a pin end at an inner side of the retaining section of the rubber-elastic membrane and are selectively fixable to one another by a transversely acting clamping mechanism, or blockable by an axially acting blocking mechanism, against longitudinal displacement with respect to the housing so as to firmly support the retaining section in accordance with a geometry of the workpiece held by the holding arrangement—the holding arrangement for the workpiece to be processed is provided in or at the retaining section of the rubber-elastic membrane and is capable of holding the workpiece without engaging the workpiece edge.

The retainer according to the invention combines different functions significant for high-quality processing of areal workpieces. Areal workpieces such as, for example, spectacle lenses, are distinguished by the fact that they have significantly larger dimensions in width direction and length direction than in thickness direction. This workpiece geometry in the case of processing by machining has the consequence that the workpiece itself particularly in the case of separating forces engaging near the edge of the workpiece and directed away from the workpiece forms a comparatively large lever arm which involves a risk of the workpiece being “levered off” its mount during the machining. At the same time, the comparatively small thickness of the workpiece specifically creates a rather small moment of resistance to bending, with the risk of an (at least) elastic deformation under the respectively prevailing processing forces. The requirements resulting therefrom for a workpiece retainer which functions reliably and is conducive to high processing quality, namely on the one hand reliably holding the areal workpiece during processing and on the other hand sufficiently supporting or propping up against undesired deformations, are addressed in special manner by the retainer according to the invention with the holding and supporting arrangements thereof.

At the outset the construction according to the invention of the support arrangement with a plurality of individually longitudinally displaceable pins, which are able to be placed against the inner side of the retaining section of the rubber-elastic membrane, advantageously makes possible a very precise “forming” to the surface, which is placed on the outer side of the retaining section, of the workpiece—which is to be retained—before the pins are clamped by the clamping mechanism, so as to provide a firm or rigid support surface for the workpiece. Thus, according to the invention there are no larger cavities present under the workpiece, into which the workpiece retained at the retainer could “deflect in” during the processing.

At the same time, the retaining section of the rubber-elastic membrane, which lies under the retained workpiece, advantageously protects the workpiece against damage at the retaining surface of the workpiece, by contrast to the pins of the workpiece mounts discussed in the introduction, which bear directly against the workpiece.

According to the invention, this protected geometrical forming and subsequent support of the workpiece can, in addition, take place up to the workpiece edge, i.e. the workpiece can rest by one side over the whole area on the mount, since the edge does not have to be kept free in order to hold the workpiece as in the prior art forming the preamble portion of claim 1, the workpiece edge in the case of the retainer according to the invention instead not having to be used for holding purposes.

The edge region of the workpiece therefore also does not have to have a predetermined shape or dimensions so that the workpiece can be held, as distinct from the prior art forming the preamble portion of claim 1. Advantageously, in the case of the retainer according to the invention the workpiece can thus have a desired edge shape and—within the scope of the dimensions of the retaining section of the rubber-elastic membrane—any desired dimensions in width, length and thickness directions of the workpiece. The retainer constructed in accordance with the invention is thus advantageously usable in highly flexible manner for the processing of the most diverse optical workpieces.

Apart from the afore-mentioned aspects of whole-area and protected support of workpieces of any shape on the retainer it is additionally provided in accordance with a further core concept of the invention to accomplish holding of the workpiece on the retainer not only not at the edge, but also exactly in the region in which support of the workpiece is also effected. For that purpose the holding arrangement for the workpiece to the processed is positioned in or at the retaining section of the rubber-elastic membrane. Thus, holding forces also cannot have a negative effect on whole-area support of the workpiece, by contrast to, for example, the clamping forces—which are introduced in radial direction in the prior art—for the workpiece, which may cause elastic deflection of the held workpiece.

In summary, the retainer constructed in accordance with the invention is capable of supporting and holding optical workpieces such as spectacle lenses during workpiece processing in a manner reliable with respect to process and without workpiece deformations detracting from processing quality. As a result, the retainer proposed here is ideal for use in a production process chain managing entirely blocklessly, such as is described in, for example, the earlier German patent application DE 10 2021 004 831.8 of the same applicant, to which reference may again be expressly made at this point with regard to process details.

Basically, different alternatives are conceivable with respect to the operating principle of the holding arrangement for the workpiece, which is to be processed, in or at the retaining section of the rubber-elastic membrane. For example, the operating principle of “adhesion” with use of an adhesive or an adhesive film at the outer side of the retaining section of the rubber-elastic membrane can be used here. A further alternative is the operating principle of “van der Waals forces” with use of, for example, a so-called “gecko” tape at the outer side of the retaining section of the rubber-elastic membrane. However, these two alternatives require specific measures in order to detach or separate the workpiece again from the retaining section of the rubber-elastic membrane after the processing; in particular, for that purpose the—possibly mechanical—application of a relatively large release force to the workpiece is required.

By contrast, a design of the holding arrangement in or at the retaining section of the rubber-elastic membrane with the operating principle of “vacuum” is particularly preferred with respect to detaching—which is easily controllable in the process sequence—of the workpiece from the retainer. Such a holding arrangement is preferably designed so that a vacuum can be applied to the chamber in the housing and a perforation as a component of the holding arrangement is formed in the retaining section of the rubber-elastic membrane so that by way of the perforation a vacuum applied to the chamber is present on the outer side of the retaining section of the rubber-elastic membrane for holding a workpiece to be processed.

A particular advantage of such a holding arrangement with the operating principle of “vacuum” is that the holding forces are simple to control not only with respect to the presence or non-presence thereof (i.e. holding force “on” or “off”) in the process, but also in their level, so that the workpiece can be held with greater or lesser strength, for example in dependence on its geometry and/or its material and the properties thereof and/or on the progress of processing and/or on the respectively acting processing forces, at the retaining section of the rubber-elastic membrane. Finally, satisfactory and easy controllability of the holding forces at the retainer is also conducive to a high level of process reliability.

It is advantageous, particularly for use of the retainer for supported holding of optical workpieces which are round as seen in plan view, such as is the case, for example, with blanks for spectacle lenses, if in a preferred embodiment the perforation of the retainer comprises a plurality of openings in the retaining section of the rubber-elastic membrane, the openings being distributed, preferably at a uniform angular spacing from one another, about a center axis of the rubber-elastic membrane on at least one pitch circle. This advantageously ensures uniform distribution of the vacuum under the held workpiece and is thus conducive to obtaining high levels of holding force capable of reliably holding the workpiece on or at the retainer even when, for example, a turning or milling tool is in machining engagement with the workpiece near the workpiece edge. Specifically for other workpiece geometries, for example in the case of workpieces which are square or rectangular as seen in plan view, the openings of the perforation can obviously also be formed in a different arrangement and/or distribution in the retaining section of the rubber-elastic membrane with the object of distribution as evenly as possible of the vacuum area between the retaining section and the workpiece resting thereon.

In a further expedient embodiment of the retainer for the operating principle of “vacuum” it can be provided that the openings of the perforation in the retaining section of the rubber-elastic membrane are substantially round and have a diameter larger than or equal to 0.5 millimeters and smaller than or equal or 2 millimeters and/or the openings of the perforation are formed in a diameter area smaller than or equal to 40 millimeters with respect to the center axis in the retaining section of the rubber-elastic membrane and/or the perforation has between 3 and 18 openings distributed on two pitch circles and/or the sub-atmospheric pressure able to be applied to the chamber lies in a range between −60 and −90 kPa.

Round openings can be particularly simple to produce in the retaining section of the rubber-elastic membrane, for example by a hole punch or in another mode and manner of punching. The diameter of the openings should in that case be so selected that on the one hand it is smaller than a diameter of the longitudinally displaceable pins of the support arrangement so that there is no risk of the pins penetrating the openings, which could lead to damage of the retained workpiece. On the other hand, however, the openings should also be large enough for air to be able to flow as free of hindrance as possible from the side of higher pressure (at the outer side of the retaining section) to the side of low pressure (at the inner side of the retaining section). The indicated diameter range has here proved advantageous in tests carried out by the inventors.

As has also resulted from these tests, in the case of workpiece diameters greater than 50 millimeters and smaller than 85 millimeters-such as is frequently the case in spectacle lens production—the claimed formation of the openings within an area of diameter smaller than or equal to 40 millimeters advantageously ensures that when a workpiece is held at the retainer there is no draw of stray air. The latter on the one hand would reduce the holding forces in an undesired way and on the other hand could transport small particles and/or cooling lubricant droplets into the chamber, where these could cause contamination of the pins and thus a possible accompanying heavy motion in the longitudinal displacement of the pins. In the afore-mentioned tests carried out by the inventors the claimed number or arrangement of the openings and pitch circles has also proved advantageous.

Finally, as regards the claimed sub-atmospheric pressure range in this connection, these sub-atmospheric pressure values were also found in the stated tests. As already mentioned, the level of vacuum can be influenced or adapted in simple manner in correspondence with the respective holding requirements to have higher values for holding forces needing to be stronger and lower values for holding forces required to be weaker. Ultimately, this variability is also advantageous with respect to energy, because it is always only necessary to generate as much sub-atmospheric pressure as actually needed. Otherwise, for generation of vacuum use can in principle be made of any desired vacuum pumps, for example positive-displacement pumps such as rotary or rotating plunger pumps, trochoidal pumps, piston pumps, rotary piston pumps or screw pumps or also jet pumps, for example with Laval nozzles. Jet pumps specially lend themselves to industrial optical production because compressed air as driving medium is already available.

In an equally preferred embodiment of the retainer with the operating principle of “vacuum” it can be further provided that arranged on the inner side of the retaining section of the rubber-elastic membrane is a semi-permeable membrane section which covers the perforation, in that case enabling air exchange by way of the perforation, but preventing passage of liquid through the perforation into the chamber. Use can be made here of, for example, a lipophilic polymer membrane such as found in water-repellent rainwear. Such a semi-permeable membrane section can serve primarily as a securing element or for system protection if in the course of processing of the workpiece held at the retainer the workpiece for whatever reason is lost, in which case the semi-permeable membrane section then prevents the chamber from, for example, being flooded with a liquid cooling lubricant as a consequence of the prevailing vacuum.

In principle it is possible to provide the chamber in the housing with a simple passage connection by way of which in holding operation of the retainer a permanent vacuum can be applied to the chamber and thus to the perforation in the retaining section of the rubber-elastic membrane. However, with respect to, in particular, highest possible energy efficiency it is preferred if there is associated with the chamber a valve which is selectively openable or closable in order in the opened state to apply a vacuum to the chamber and in the closed state to maintain the vacuum in the chamber when a workpiece is held at the retaining section of the rubber-elastic membrane by way of the perforation. Thus, the vacuum can be advantageously kept in the chamber without a vacuum pump having to constantly operate. Moreover, release of the processed workpiece from the retainer can advantageously be controlled in simple manner by way of such a valve at the chamber.

Further, as far as the support arrangement of the retainer with its longitudinally displaceable pins suitably “packed” in the chamber is concerned, these can basically be arranged in the chamber to be freely longitudinally movable when clamping by the clamping mechanism is removed. Adaptation or forming to the geometry of the workpiece to be held at the retaining section of the rubber-elastic membrane can then take place under external forces in that, for example, the retainer is “placed” from above on a workpiece, which is to be held, by the retaining section of its rubber-elastic membrane. In that case the pins freed by the clamping mechanism bear under the action of gravitational acceleration by the mass thereof against the inner side of the retaining section of the rubber-elastic membrane and as a consequence of the thus-acting gravitational force urge the flexible retaining section by its outer side against the workpiece to be retained. If the retaining section of the rubber-elastic membrane then bears by its outer side over the whole area against the opposing surface of the workpiece to be held the pins can be clamped against one another by the clamping mechanism so that the copied area geometry is quasi “frozen” and the retainer is consequently capable of firmly supporting the workpiece. In principle, instead of gravitational force use can also be made of other forces, which externally act on the pins, for the forming process, for example a magnetic force acting on the pins via the workpiece.

However, an embodiment of the retainer in which the pins of the support arrangement are spring-biased in the direction of the retaining section of the rubber-elastic membrane is preferred over the afore-described gravitational force solution, especially with respect to directional independence in the forming process.

In a first alternative of such a “spring solution”, the arrangement can preferably be such that a helical compression spring is associated with each pin of the support arrangement so as to produce the spring bias in the direction of the retaining section of the rubber-elastic membrane. By comparison with an equally conceivable “common” spring for several or all pins-such as can be realized, for example, by one (or more) areal flexible foam bodies which bear by one side against the pin ends remote from the retaining section of the rubber-elastic membrane, whilst it is supported on the other side in the housing of the retainer—the main advantage of an “individual” spring for each pin resides in independence of movement of the individual pin from the other pins. This movement independence of the pins from one another enables very good adaptation of the retaining section of the rubber-elastic membrane to different surface geometries at the workpiece to be retained.

As an example, mention may be made at this point of a so-called “bifocal lens” for spectacles as possible workpiece to be retained, which achieves two optical effects and accordingly is usable for different distances. Such bifocal lenses are usually recognizable by the sharp separating line between the two lens regions, along which such a spectacle lens has a step. It is immediately clear that such discontinuities in the geometry of the workpiece to be retained can be better reproduced at the retaining section of the rubber-elastic membrane if the pins urging the retaining section against the workpiece are individually spring-biased.

In a second alternative of the afore-mentioned “spring solution” the embodiment can be preferably such that the pins of the support arrangement are spring-biased in the direction of the retaining section of the rubber-elastic membrane with the help of at least one pneumatic spring element. The main advantages of a pneumatic spring element reside in the variability of the pressing force, which can be easily set by pressure increase or decrease in the pneumatic spring element, as well as the comparatively small dependence on spring travel.

By way of example, mention may be made at this point of a spectacle lens with a prismatically tilted or strongly curved front surface as a possible workpiece to be retained. If in the case of such a workpiece the pins are individually spring-biased in correspondence with the above-discussed first alternative of the “spring solution”, then during forming to the workpiece surface there are pins which have to relatively strongly deflect at the workpiece regions axially “near” the retaining section of the rubber-elastic membrane and pins which only comparatively weakly deflect at the workpiece regions axially “distant” from the retaining section. As a consequence of the linear spring characteristic of the individual springs there can thus be large differences over the workpiece surface, which is to be retained, in the level of the reaction forces which act from the springs on the workpiece and which can lead to internal stresses in the workpiece particularly in sub-regions of thin workpieces. It is immediately clear that this problem does not exist in the case of a pneumatic spring element for spring biasing of the pins.

In the case of selection of the alternative, which is offered for the respective case of use of the retainer, for possible—and here preferred—spring-biasing of the pins the person skilled in the art thus also has to take into consideration, in particular, the geometry that the workpiece to be held has at the workpiece surfaces to be retained.

In an advantageous development of the “spring solution” with the pneumatic spring element the latter can comprise a flutter valve which closes when there is pressure loading of the pneumatic spring element for contact of the pins of the support arrangement with the retaining section of the rubber-elastic membrane and opens when there is vacuum loading of the pneumatic spring element, so as to apply the vacuum to the chamber bounded by the rubber-elastic membrane. In principle, the pneumatic spring element for the pins of the support arrangement can, in fact, also be designed in such a way that it has no pneumatic connection with the chamber, which is bounded by the rubber-elastic membrane, in the housing even though it can be acted on in defined manner with compressed air by way of a pressure connection so as to provide the desired spring characteristics. In this case the chamber in the housing would be provided with a separate sub-atmospheric pressure connection so that a vacuum can be applied to the perforation in the retaining section of the rubber-elastic membrane.

However, by comparison with such a possible variant of the “spring solution” the claimed embodiment of the pneumatic spring element with the flutter valve is in overall construction distinctly less complicated for vacuum loading of the chamber bounded by the rubber-elastic membrane, because a simple rotary feedthrough at the workpiece spindle carrying the retainer is sufficient in order to selectively act on the retainer with pressure (pneumatic spring of the support arrangement active) or to evacuate it (holding arrangement active). The construction with the flutter valve at the pneumatic spring element in that regard handily exploits the circumstance that the pneumatic spring element is needed merely for laying the retaining section of the rubber-elastic membrane against the workpiece, which is to be retained, by way of the force-transmitting pins of the support arrangement in the chamber before the pins are clamped together by the clamping mechanism, whereupon only then is the vacuum to be applied to the perforation of the holding arrangement so as to hold the workpiece. In other words, the pneumatic spring element for shaping or forming to the workpiece geometry at the retainer and the perforation for holding the workpiece at the shaped retainer are never used at the same time, so that with advantage the vacuum loading of the holding arrangement can also take place by way of the pneumatic spring element provided with the flutter valve.

Basically it is possible to accommodate the longitudinally displaceable pins in the chamber in a packed arrangement having an approximately circularly round or a polygonal cross-section. However, an embodiment of the retainer is preferred in which the longitudinally displaceable pins of the support arrangement are arranged in a housing in a substantially hexagonal package, for which purpose the housing has a guide section having an opening which is substantially hexagonal as seen in cross-section and through which the pins extend. By virtue of the substantially six-sided arrangement as seen in cross-section a maximum density of packing of the longitudinally displaceable pins results, which is especially advantageous for reliability of clamping of the pins by the transversely acting clamping mechanism. Moreover, between the pins ends facing the inner side of the retaining section of the rubber-elastic membrane there are thus only gaps of minimal size between the tightly packed pins, just large enough to conduct the vacuum to the perforation of the holding arrangement and obviously small enough to be covered or bridged over by the retaining section without compromising firm area support of a workpiece held at the retainer.

As far as the pins themselves are concerned, these can in principle have any desired, for example polygonal, cross-section. However, particularly with respect to simple and economic production of the pins—which after all are present in the chamber of the retainer in large number (for example about 500 pieces in an actual embodiment)—it is preferred if the longitudinally displaceable pins of the support arrangement are cylindrical pins each with an offset clamping region of greatest diameter for clamping by the clamping mechanism, wherein the pins linearly bear against one another by their clamping regions and/or the clamping regions of the pins have an outer diameter of between 2.5 and 4.5 millimeters. A further advantage of the cylindrical form of the pins is that the pins do not have to be guided against turning about the longitudinal axes thereof, but instead can automatically adopt a desired rotational setting. In the case of the tests of the inventors as already mentioned further above it has furthermore proved that an outer diameter of the pins in the claimed range represents a very good compromise between a highest possible “grid resolution” for the area support of the workpiece on the one hand and a still adequate easy motion in the longitudinal displacement of the individual pins on the other hand. However, a smaller outer diameter of the pins is basically also conceivable, for example in a range between 1 and 2.5 millimeters.

In an expedient embodiment of the retainer it can further be provided that the longitudinally displaceable pins of the support arrangement extend by their pin ends through at least one apertured limiting plate which limits longitudinal movement of the pins in the housing, namely through forming an abutment for the thickened middle region of the pins. This primarily represents an easily realizable protection of the rubber-elastic membrane, which cannot be excessively deflected by the pin packet optionally spring-biased in the direction of the retaining section, since due to the limiting plate the pins cannot move in this direction unhindered.

A similar principle—axial blocking—is conceivable in order to fix the individual pins of the pin packet in a once-adopted axial setting against further longitudinal displacement. Such an axially acting blocking mechanism could, for example, operate with a medium which with introduction of energy is selectively capable of “swelling up” or has a variable aggregate state—such as, for example, water or a metallic alloy of low melting point—and which surrounds the pin ends, which are optionally formed to be thickened, on the side of the pins remote from the retaining section of the rubber-elastic membrane or is present thereat with an elastic membrane therebetween. Through selectively triggered swelling or rigidifying of the medium the individual pins can then be blocked in their respectively adopted setting so that the geometry formed at the retaining section of the rubber-elastic membrane in correspondence with the shape of the workpiece to be retained “rigidifies”. The longitudinally displaceable state of the pins can then be produced again by reversal of the measures undertaken.

Moreover, the clamping force, which acts transversely to the pins of the support arrangement, for the pins can in principle be exerted on the pins in a different way. By way of example, clamping mechanisms are conceivable in which a wedge or several wedges is or are driven in axial direction of the pins into the center of the pin packet between the pins similarly to the wedge solution disclosed in document WO 2009/135689 A1 (FIGS. 7 and 8) or in radial direction starting from the outer circumference of the pin packet analogously to the wedge solution shown in document WO 2016/058676 A1 (FIG. 5).

However, by comparison with such wedge solutions a design of the retainer is preferred in which the clamping mechanism comprises at least one force transmission element—for example in the form of a market-available round-ended or straight-ended key—by way of which a clamping force is transmissible to the pins, which runs from a side of the housing substantially in the direction of a center axis of the housing and acts perpendicularly to the longitudinal axes of the pins. It has proved in the tests undertaken by the inventors that in the case of such an application of clamping force, which in departure from the previously known wedge solutions takes place not from the center of the pin packet radially outwardly or substantially in circumferential direction at the edge of the pin packet, but from radially outwards towards the center axis without penetration of a “displacer” between the pins, the individual pins of the plurality of pins in accordance with the invention experience better, i.e. firmer, clamping with one another for a comparatively small applied clamping force and thus guarantee particularly reliable support of the retained workpiece.

In a particularly simple embodiment of the clamping mechanism it can additionally be provided that the force transmission element can be mechanically loaded with the clamping force by way of at least one set screw mounted on the housing. Alternatively, for example, pneumatic, hydraulic or electrical actuators are obviously also conceivable for transverse loading of the pins with force and feasible in correspondence with the respective requirements for automation. The same applies to arrangements in which a change in the aggregate state of a transmission medium or a temperature change at a solid transmission material is accompanied by volume changes in the medium or material (volume increase or volume decrease), which can be used for transverse loading of the pins with force.

Further, as far as the rubber-elastic membrane of the retainer is concerned it can be provided in a preferred embodiment of the retainer that the rubber-elastic membrane is supported radially outside the pins, which bear against the retaining section, of the support arrangement by at least one resiliently deformable shaped part, particularly a shaped ring of a foam material. In that regard, it can in principle be a separate insert part or a section foamed in place at the membrane. Thus, collapse of the rubber-elastic membrane under the action of the vacuum in the chamber at the housing can be avoided in particularly simple manner. However, it is alternatively also possible to provide the rubber-elastic membrane in sub-regions with larger wall thicknesses and/or to stiffen it with a suitable reinforcement, although this is less preferred with respect to an optimal capability of adaptation of the membrane to the workpiece to be held.

In the tests conducted by the inventors it has further proved to be particularly advantageous again especially with respect to a best possible capability of adaptation of the membrane to the workpiece to be retained if the rubber-elastic membrane is made of NBR or EPDM and/or has a hardness according to Shore A between 45 and 90 and/or a material thickness greater than or equal to 1.0 and smaller than or equal to 2.5 millimeters.

Finally, an embodiment of the retainer is preferred in which the housing has a securing section for exchangeable securing to a workpiece spindle or the like. Thus, the retainer can be used in various ways: 1) The retainer can be fixedly installed in the respective processing machine, wherein the workpiece is secured to the retainer, subsequently processed and then detached again from the retainer. 2) The retainer with mounted workpiece can be brought in a machine from one work station to another work station. Thus, for example, in spectacle lens production different working steps such as generating, polishing and marking could be performed in a machine at different positions. 3) The retainer with mounted workpiece can also be transported from one machine to the next machine and thus be newly clamped in each instance by way of a zero point clamping system in the manner of a “reusable block piece”.

Further features, characteristics and advantages of the retainer according to the invention are evident to the person skilled in the art from the following description of preferred examples of embodiment.

### BRIEF DESCRIPTION OF THE DRAWINGS

The invention is explained in more detail in the following by way of preferred embodiments with reference to the accompanying partly schematic drawings, in which the same or corresponding parts or sections are provided with the same reference numerals and in which:

FIG. 1 shows a perspective view of a combined CNC milling/turning machine for the processing of, in particular, spectacle lenses as optical workpieces (also called “generator”) from obliquely above and front left, at the central workpiece spindle of which a retainer according to the invention for workpiece processing is mounted and with which a 6-axis articulated arm robot serving especially for workpiece feed to the machine is associated, wherein for simplification of the illustration merely the subassemblies in or at the machine which co-operate with the workpiece spindle or the 6-axis articulated arm robot are illustrated;

FIG. 2 shows an enlargement of the detail II in FIG. 1 for illustration of further details with respect to the subassemblies, which co-operate with the 6-axis articulated arm robot, at the machine according to FIG. 1;

FIG. 3 shows a perspective view, which is broken away at all sides, of the machine according to FIG. 1 from obliquely above and front right and to the scale of FIG. 2, wherein of the 6-axis articulated arm robot in order to free a view of subassemblies therebehind merely a workpiece retaining head, which is mounted at the free end of the robot and is opposite the retainer according to the invention, is illustrated in broken-away form and in the foreground a conveyor belt of the machine automated system with a prescription box arranged thereon for workpieces and optionally tools (so-called “job tray”) is shown;

FIG. 4 shows a plan view of the machine according to FIG. 1 without the subassemblies installed on the right at the machine frame of the machine in FIG. 1, but with the 6-axis articulated arm robot;

FIG. 5 shows a perspective view of the retainer, which is separated or demounted from the workpiece spindle of the machine according to FIGS. 1 to 4, in accordance with a first example of embodiment of the invention, wherein at an end retaining section of a rubber-elastic membrane of the retainer there are indicated—by dashed lines—part circles on which openings of a perforation of the rubber-elastic membrane are arranged as a component of a workpiece holding arrangement, which operates with the operating principle of vacuum, of the retainer;

FIG. 6 shows a plan view of the retainer illustrated in FIG. 5;

FIG. 7 shows a side view of the retainer according to FIG. 5, wherein on the lefthand side in FIG. 7 a hollow-cylindrical retaining section of the workpiece spindle of the machine shown in FIGS. 1 to 4 is illustrated broken away on the left for clarification of the connection situation for the retainer at or in the machine;

FIG. 8 shows an enlargement of the detail VIII in FIG. 6, which illustrates an opening of the perforation in the retaining section of the rubber-elastic membrane of the retainer;

FIG. 9 shows a sectional view of the retainer according to FIG. 5 in correspondence with the angled section line IX-IX in FIG. 6, wherein a valve by way of which a vacuum can be applied to a chamber of the retainer is illustrated in a closed state on the lefthand side of FIG. 9;

FIG. 10 shows a sectional view, which is broken away on the left, of the retainer according to FIG. 5 similar to the illustration in FIG. 9, wherein the retaining section of the rubber-elastic membrane is adapted in terms of shape to the geometry of a spectacle lens which is to be processed and which is, as shown, held at the retainer with support over the whole area;

FIG. 11 shows an enlargement of the detail XI in FIG. 9, which illustrates how the individual longitudinally displaceable pins of a pin packet received in the chamber of the retainer are, for workpiece support, spring-biased by helical compression springs in the direction of the retaining section of the rubber-elastic membrane;

FIG. 12 shows a sectional view, which is broken away on the right, of the valve, which is also illustrated in section in FIG. 9, of the retainer according to FIG. 5, the valve being shown in an open state;

FIG. 13 shows a sectional view of the retainer according to FIG. 5 in correspondence with the section line XIII-XIII in FIG. 7, which illustrates how the individual pins of the support arrangement are fixable to one another by a transversely acting clamping mechanism, which comprises three uniformly angularly spaced force transmission elements in the form of keys able to be loaded with force by way of set screws, wherein a clamping variant comprising three set screws instead of only one set screw is shown in a sub-region which is upper in FIG. 13 and delimited by a dot-dashed line;

FIG. 14 shows a longitudinal sectional view, which is similar to FIG. 9, but different in sectional course, of a retainer according to a second example of embodiment of the invention, in which the individual longitudinally displaceable pins of the support arrangement are spring-biased by a common pneumatic spring element in the direction of the retaining section of the rubber-elastic membrane;

FIG. 15 shows an enlargement of the detail XV in FIG. 14 for closer illustration of a flutter valve provided at the pneumatic spring element for relief; and

FIG. 16 shows a perspective view of the pneumatic spring element, which is separated from the retainer according to FIG. 14, with a view of a valve flap of the flutter valve for relief of the chamber of the retainer.

### DETAILED DESCRIPTION OF THE EMBODIMENTS

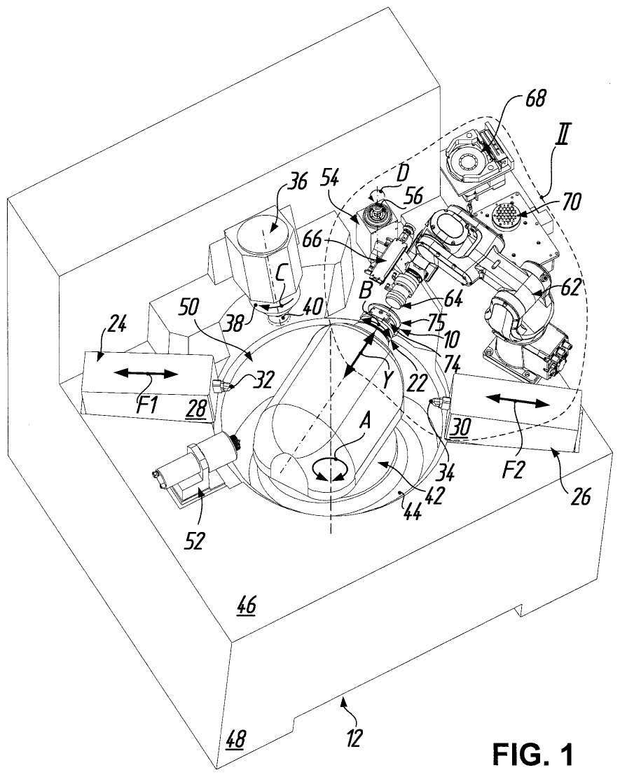

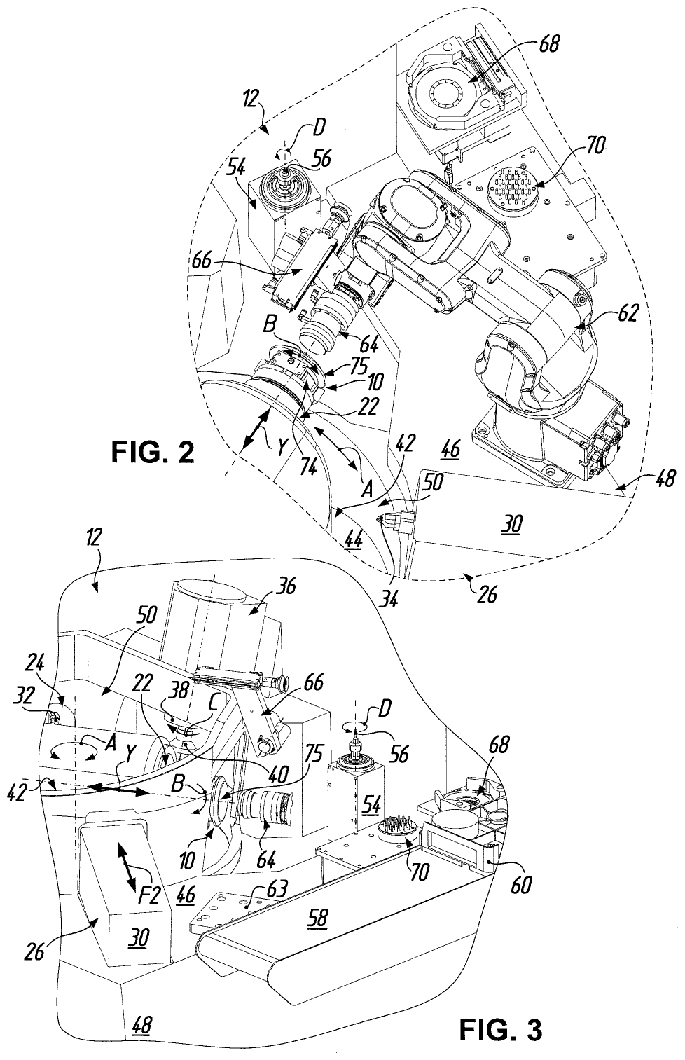

A combined CNC milling/turning machine for processing of, in particular, spectacle lenses is illustrated in FIGS. 1 to 4 by way of example for a technical sphere in which use can be made of a workpiece retainer 10 described in detail in the following on the basis of FIGS. 5 to 16 by two embodiments, the machine here termed in the following—as also in this sector—generator 12. Such generators 12 are available from Satisloh A G, Baar, Switzerland, under the commercial designation “VFT-orbit” and are the subject of document EP 2 011 603 A1, to which at this point express reference may be made at the outset with respect to construction and function of the generator 12.

A spectacle lens 14 as an example of an optical workpiece to be processed in shown in FIG. 10. The spectacle lens 14 has two—optically effective at least at the end of the processing—workpiece surfaces 16, 18 and a workpiece edge 20 therebetween. In the different processing states, i.e. starting from the spectacle lens blank through the partly processed spectacle lens semi-finished product to the spectacle lens processed to finished state, there is always an areal workpiece. As such, the spectacle lens 14 during processing has to be reliably held and at the same time supported against undesired deformations, a purpose served by the retainer 10 described herein.

In brief, the generator 12 according to FIGS. 1 to 4 comprises a workpiece spindle 22 by which the spectacle lens 14 held in supported manner at the retainer 10 can be rotationally driven about a workpiece axis B of rotation. In addition, the generator 12 in the illustrated example of embodiment has three processing units for processing by machining of the spectacle lens 14 held at the workpiece spindle 22 by way of the retainer 10, namely two turning processing units 24, 26 each with a fast-tool servo 28, 30, which serves the purpose of producing a linear movement in direction F1 or F2 for a respectively associated turning cutter 32, 34 as turning tool, as well as a milling processing unit 36 with a workpiece spindle 38 for producing a rotational movement about a tool axis C of rotation for a milling tool 40. Moreover, the generator 12 comprises an adjusting mechanism, which is denoted generally by 42, for producing a relative movement between the workpiece spindle 22 and the respective tool 32, 34, 40 so as to enable (at least) selectively loading/unloading or machining of the spectacle lens 14. In that regard the adjusting mechanism 42 comprises a linear drive unit as well as a pivot drive unit (neither to be seen in the figures) which are arranged one on the other, wherein the workpiece spindle 22 is pivotable by the pivot drive unit about a pivot axis A, which is substantially perpendicular to the workpiece axis B of rotation, whilst the workpiece spindle 22 is movable by the linear drive unit along a linear axis Y extending substantially perpendicularly to the pivot axis A and substantially parallely to the workpiece axis B of rotation.

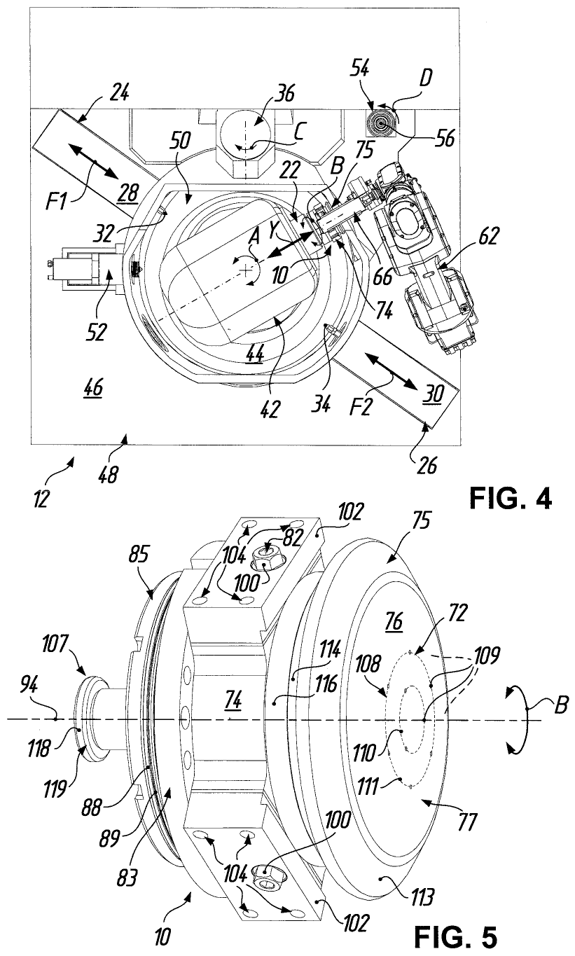

The adjusting mechanism 42 is arranged in the center of an annular trough-like recess 44 which starting from an upper side 46 is formed centrally in a machine frame 48 formed monolithically from polymer concrete and which bounds a work space 50 of the generator 12. Let into the machine frame 48 around the recess 44, as shown particularly in FIG. 4, and starting from the upper side 46 are a plurality of flange surfaces which serve for mounting the operating units 24, 26, 36 in a star-like arrangement about the work space 50 and further units or stations which are to be briefly described in the following.

According to FIGS. 1 and 4 and to begin with, a measuring station 52 for measuring the spectacle lenses 14, particularly for calibration of the generator 12, is present directly at the recess 14 in the machine frame 48. In addition, provided just to the right of the milling processing unit 36 in FIGS. 1 to 4 is a further small milling spindle 54—equipped with suitable encapsulation and swarf suction removal (not shown)—by which an end mill 56 can be rotationally driven about a further tool axis D of rotation under rotational speed control. This processing unit serves the purpose of forming at the spectacle lens blank by the end mill 56 an encircling groove, step or an encircling cut (not shown) in the workpiece surface 16 before processing of the other workpiece surface 18 of the spectacle lens blank then held at the retainer 10 begins. This procedure for pre-edging or finish-edging in the processing of spectacle lenses 14 is described in detail in the earlier German patent application DE 10 2021 004 831.8 of the same applicant, to which at this point express reference may be made with regard to details of the method.

Finally, FIGS. 1 to 4 also show (a) a transport device (FIG. 3), which is mounted laterally on the machine frame 48, with a conveyor belt 58 for transport of prescription or job trays 60 in which the spectacle lenses 14 which are to be processed or are processed are transported; (b) a 6-axis articulated arm robot 62 (FIGS. 1, 2 and 4), which is flange-mounted on the upper side 46 of the machine frame 48 (see FIG. 3: flange surface 63) and carries at its free end a workpiece retaining head 64 and which serves especially for workpiece feed of the generator 12 as well as for holding and positioning the spectacle lenses 14 at the milling spindle 54; (c) a workpiece turning device 66, which is pivotably held at the machine frame 48 of the generator 12 by way of a holding structure (not shown) and which is functionally arranged between the retainer 10, which is held at the workpiece spindle 22 of the generator 12, and the workpiece retaining head 64 of the 6-axis articulated arm robot 62; (d) an imaging station 68 (FIGS. 1 to 3) for positional determination of the spectacle lens blank; and (e) a measuring station 70 (FIGS. 1 to 3) for measuring the front curve of the spectacle lens blank. The 6-axis articulated arm robot 62 is in a position of being able to transport spectacle lenses 14, which are to be processed or are processed, by its workpiece retaining head 64 between the job tray 60 on the conveyor belt 58, the imaging station 68, the measuring station 70, the milling spindle 54, the workpiece turning device 66 and—as indicated in FIG. 3—the retainer 10 at the workpiece spindle 22 of the generator 12 and positioning the lenses at the respective location in correspondence with the processing and/or handling requirements respectively assigned thereto.

With regard to the further kinematics of the afore-described generator 12, it is also to be noted that the workpiece spindle 22 is movable by the adjusting mechanism 42, which comprises a linear drive unit and a pivot drive unit, under CNC positional regulation (A axis, Y axis) in a plane extending perpendicularly with respect to the pivot axis A, whilst the spectacle lens 14 held at the retainer 10 is rotatable in rotational angle under CNC positional regulation (B axis) about the workpiece axis B of rotation. The spectacle lens 14 can thus be moved from one processing unit or station to the next processing unit or station (A axis) and/or with respect to a processing unit or station transversely thereto (A axis, optionally combined with Y axis, particularly for advance movements) and/or with respect to a processing unit or station in direction towards or away from this (Y axis, particularly for adjusting movements). In that case, on the tool side the milling tool 40 can be rotationally driven by the workpiece spindle 38 of the milling processing unit 36 about the tool axis C of rotation under rotational speed control or the respective turning cutter 32, 34 can be reciprocatingly adjusted by the associated fast-tool servo 28 30 along the respective linear axis F1, F2 under CNC positional regulation and in accordance with the surface shape to be generated at the spectacle lens 14, so as to take off cutting chips.

Further details of the retainer 10 according to the first embodiment can be inferred from FIGS. 5 to 13. In general, the retainer 10 comprises, for the afore-mentioned functions of “holding” and “supporting” a spectacle lens 14 to be processed, a holding arrangement 72 and a support arrangement 73, both of which are described in more detail in the following. In this connection, the retainer 10 has first of all a multi-part housing 74 on which a rubber-elastic membrane 75 is mounted. The rubber-elastic membrane 75 has a retaining section 76, on the outer side 77 of which the spectacle lens 14 according to FIG. 10 can be areally placed by one (16) of its workpiece surfaces 16, 18.

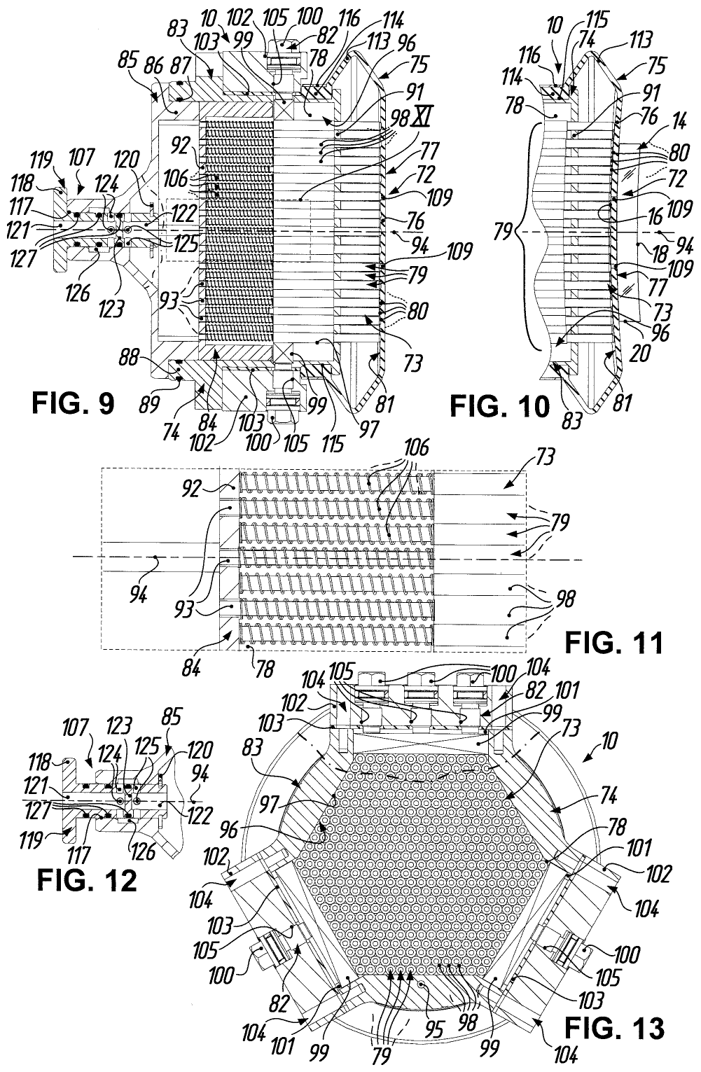

Moreover, the rubber-elastic membrane 75 bounds, together with the housing 74, a chamber 78 (see, in particular, FIGS. 9 and 10) in which a plurality of separate longitudinally displaceable pins 79 of the support arrangement 73 is accommodated. The pins 79 can each be brought into contact with a pin end 80 at an inner side 81 of the retaining section 76 of the rubber-elastic membrane 75. Furthermore, the pins 79—as is also described in more detail in the following—can be selectively fixed relative to one another by a transversely acting clamping mechanism 82 against longitudinal displacement with respect to the housing 74 so as to firmly support the retaining section 76 of the rubber-elastic membrane 75 in accordance with a geometry of the spectacle lens 14 held by the holding arrangement 72 (see the convex curvature of the surface 16 of the spectacle lens 14 in FIG. 10). According to a significant feature of the retainer 10 the holding arrangement 72 for the spectacle lens 14 to be processed is in that case provided in or at the retaining section 76 of the rubber-elastic membrane 75, where it is capable of holding the spectacle lens 14 alone against the workpiece surface 16 without engaging the workpiece edge 20 of the spectacle lens 14, as can be seen in FIG. 10.

The individual parts of the multi-part housing 74 of the retainer 10 can be best seen in FIG. 9. Accordingly, the housing 74 in a first embodiment comprises three parts, namely a base 83, a support flange 84, which is received in the chamber 78 of the housing 74 and is surrounded by the base 83, for the pins 79 and a sealing flange 85 bounding the chamber 78 in the housing 74 on the left in FIG. 9. The sealing flange 85 is inserted by a shoulder 86 into the base 83 with sealing by a sealing ring 87 and suitably secured, for example by a screw connection (not shown). The sealing flange 85 keeps the support flange 84 in the chamber 78 by the end, which is on the right in FIG. 9, at the shoulder 86. At the circumferential side the base 83 is also provided with a sealing ring 89 in the region of a hollow-cylindrical securing section 88 on the left in FIG. 9. This securing section 88 of the housing 74 serves for exchangeable securing of the retainer 10 to a hollow-cylindrical end section 90 of the workpiece spindle 22, which is illustrated in broken-away form in FIG. 7.

As can also be seen in FIG. 9, not only the base 83, but also the support flange 84 of the housing 74 are formed to be substantially cup-shaped, each with a base region which is formed by an apertured limiting plate 91 or 92 through which the longitudinally displaceable pins 79 of the support arrangement 73 extend by their mutually remote pin ends 80 or 93. For that purpose the base 83 and the support flange 84 are suitably aligned with respect to one another in their rotational position about a center axis 94 of the retainer 10 and are drilled in common and secured by a cylindrical pin 95 (see FIG. 13) against relative rotation with respect to one another.

According to FIG. 13 the longitudinally displaceable pins 79 of the support arrangement 73 are moreover arranged in the housing 74 of the retainer 10 in a very tight, substantially hexagonal package. For that purpose the housing 74, more precisely the base 83 thereof, has a guide section 96 having an opening 97 which is substantially hexagonal as seen in cross-section and through which the pins 79 extend.

In addition, as can best be inferred from the enlargement according to FIG. 11 as well as the section according to FIG. 13, in the illustrated example of embodiment the longitudinally displaceable pins 79 of the support arrangement 73 are cylindrical pins each with an offset clamping region 98 of greatest diameter for clamping by the clamping mechanism 82 to be described in more detail in the following. In their packed arrangement the pins 79 bear linearly against one another by the clamping regions 98 thereof. In their clamping regions 98 the pins 79 can in that case have, for example, an outer diameter of between 2.5 and 4.5 millimeters. For the dimensioning of the pins 79 it is to be taken into consideration on the one hand that the pins 79 should not be too thick, so that a highest possible resolution is achieved when shaping to the usually curved workpiece surfaces 16 of the spectacle lenses 14 to be retained at the retainer 10. On the other hand, the diameter of the pins 79 in downward sense is limited primarily by production requirements or production possibilities. As far as the number of pins 79 is concerned, 469 pins with a diameter of 3 millimeters are needed for, for example, a hexagonal pin package with a “spanner width” of 65 millimeters—in correspondence with the maximum fully supported circular shape of a spectacle lens 14 to be retained—and a corner dimension of 75 millimeters. In another variant with a hexagonal pin package having a spanner width of 86 millimeters and a corner dimension of 100 millimeters, this would be 469 pins with a diameter of 4 millimeters. The thickened clamping regions 98 of the pins 79 can have, for example, a length of approximately 20 millimeters in correspondence with the length of the hexagonal opening 97 in the base 83 of the housing 74, so that guidance of the pins 79 to counteract “canting” of the pins 79 is also given by way of this length.

As indicated in FIGS. 9 and 10, the pins 79 are in addition formed to be slightly rounded or lens-shaped at their pin ends facing the inner side 81 to the retaining section 76 of the rubber-elastic membrane 75. This is conducive, in the shaping to different radii of curvature of the spectacle lens 14 to be retained, to best possible workpiece support by the pins 79 and moreover counteracts membrane damage on contact of the pin ends 80 with the inner side 81 of the rubber-elastic membrane 75.

Details of the clamping mechanism 82 can be best inferred from FIGS. 9 and 13. Accordingly, the clamping mechanism 82 comprises at least one force transmission element 99, but in the illustrated embodiment and particularly for avoidance of imbalance three force transmission elements 99 arranged to be angularly offset by 120° with respect to the center axis 94 of the retainer 10, the elements here in the form of commercially available rounded-end keys. A respective clamping force is transmissible by way of the force transmission elements 99 to the clamping regions 98 of the pins 79, the force running from a side of the housing 74 substantially in the direction of the center axis 94 of the housing 74 and acting perpendicularly to the longitudinal axes of the pins 79.

In the illustrated embodiment, each force transmission element 99 can be mechanically acted on by a clamping force via at least one set screw 100 mounted on the housing 74. More specifically, the force transmission elements 99 are each received in an associated cut-out 101 (see FIG. 13), which is of complementary shape and is open radially outwardly, of the base 83 of the housing 74. Each cut-out 101 is outwardly covered by a clamping plate 102, which is fixedly screw-connected with the base 83—with interposition of an area seal 103—by screws (not shown in the figures) at screw points 104. According to FIGS. 9 and 13 the set screws 100 pass through associated threaded bores 105 in the clamping plates 102 and are in contact by their screwed-in ends with the force transmission elements 99. For clamping of the clamping regions of the pins 79 it is sufficient to tighten only one set screw 100, which thus acts on the associated force transmission element 99. In that case the pins 79 are supported against one another by the clamping regions 98 thereof and at the two other force transmissions elements 99, which in turn are supported on the respectively associated set screw 100. As a consequence of the circumferential distribution of the set screws 100 at the retainer 10 it is simple to access one of the set screws 100 in correspondence with the rotational angle setting of the workpiece spindle 22 in the generator 12 and thus of the retainer 10 so as to actuate the clamping mechanism 82.

In addition, a variant of the clamping mechanism 82 is illustrated in the upper part of FIG. 13, in which instead of one set screw three set screws 100 engage the associated force transmission element 99 so as to counteract canting of the force transmission element 99 in the cut-out 101. In an actual realization of this variant obviously three set screws 100 would be associated with each of the force transmission elements 99 so as to avoid imbalance in the case of rotational movement of the retainer 10 about the center axis 94.

In the illustrated embodiment a further important aspect in connection with the pins 79 of the support arrangement 73 is that the pins 79 are spring-biased in the direction of the retaining section 76 of the rubber-elastic membrane 75. In the first embodiment according to FIGS. 5 to 13 a helical compression spring 106 is associated with each pin 79 of the support arrangement 73 so as to produce at the respective pin 79 an individual spring-bias in the direction of the retaining section 76 of the rubber-elastic membrane 75.

Further details with respect to this arrangement of the helical compression springs 106 in the retainer 10 can be inferred from FIG. 11. The helical compression springs 106 are each subject to a small deflection by way of the pin ends 93, which are remote from the rubber-elastic membrane 75, of the pins 79 so that they bear by their ends on the right in FIGS. 9 and 11 against the thickened clamping regions 98 of the pins 79, whilst the ends of the helical compression springs 106 on the left in FIGS. 9 and 11 are supported on the apertured limiting plate 92 of the support flange 84 of the housing 74, through which the pins 79 extend by their pin ends 93. It will be apparent that each individual pin 79 thereby experiences a spring bias in the direction of the retaining section 76 of the rubber-elastic membrane 75. In the basic setting of the retainer 10 (FIG. 9) the apertured limiting plate 91 of the base 83 of the housing 74 in that case limits movement of the pins 79 in the direction of the retaining section 76, wherein the pins 79, which penetrate the limiting plate 91 by their pin ends 80, bear by their thickened clamping regions 98 against the limiting plate 91. If the clamping mechanism 82 is released, the individual pins 79 deflect out of this setting when a spectacle lens 14 is retained at the retaining section 76 of the rubber-elastic membrane 75, so that the thickened clamping regions 98 of the pins 79 lift off or come out of contact with the limiting plate 91 of the housing 74 against the force of the helical compression springs 106, as shown in FIG. 10. If the workpiece surface 16 of the spectacle lens 14, which is to be retained, is fully copied the clamping mechanism 82 can be actuated so that as a consequence the pins 79 are held in the respective setting thereof and the formed shape of the retaining section 76 is “frozen”.

Further details of the holding arrangement 72 of the retainer 10 can be inferred particularly from FIGS. 5 to 9 and 12. In the illustrated embodiment, firstly a vacuum can be applied to the chamber 78 in the housing 74, for which purpose a valve 107, which is described in more detail later, is associated with the chamber 78. In addition, as a component of the holding arrangement 72 a perforation 108 is formed in the retaining section 76 of the rubber-elastic membrane 75, as can be best seen in FIGS. 5, 6 and 8, so that by way of the perforation 108 a vacuum applied to the chamber 78 prevails on the outer side 77 of the retaining section 76 of the rubber-elastic membrane 75 for holding a spectacle lens 14 to be processed.

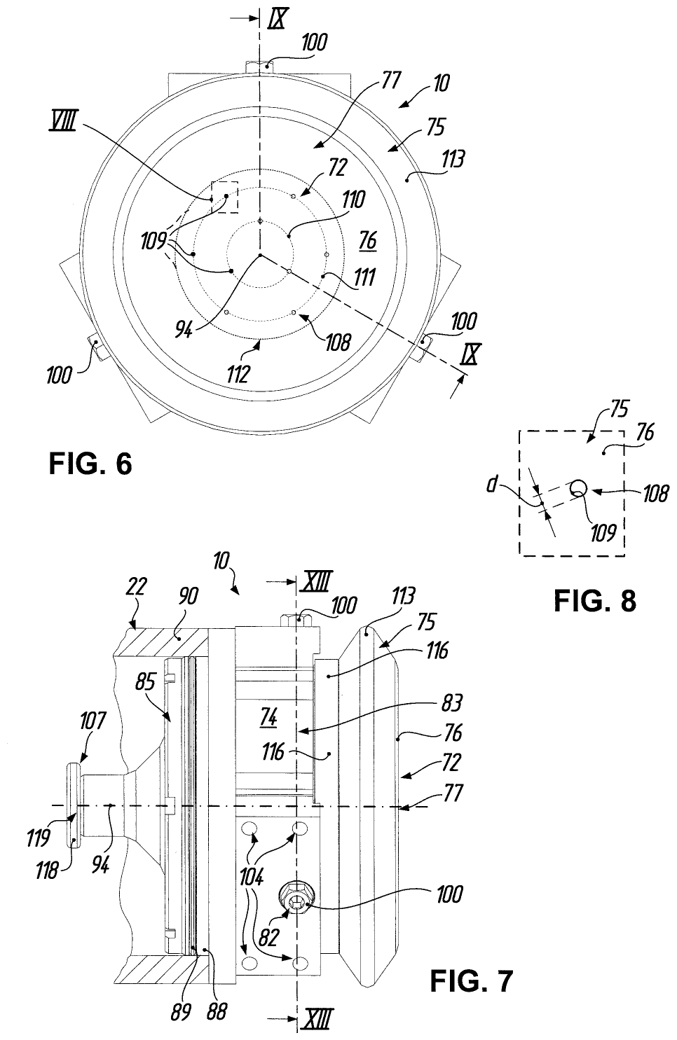

More precisely, the perforation 108 comprises a plurality of openings 109 in the retaining section 76 of the rubber-elastic membrane 75, the openings being distributed around the center axis 94 of the rubber-elastic membrane 75 at uniform angular spacings from one another on at least one pitch circle, in the illustrated embodiment two pitch circles 110, 111 which are indicated in FIGS. 5 and 6 by dashed lines. By way of example, the perforation 108 can thus have between three and eighteen openings 109 distributed on two pitch circles 110, 111; specifically, in FIGS. 5 and 6 three openings 109 are shown on the inner pitch circle 110 and six openings 109 on the outer pitch circle 111. The openings 109 of the perforation 108 are in that case preferably formed in a diameter area smaller than or equal to 40 millimeters with respect to the center axis 94 in the retaining section 76 of the rubber-elastic membrane 75 so that they can be covered by a blank for a spectacle lens 14 with usual dimensions.

As the enlargement according to FIG. 8 additionally shows, the openings 109 of the perforation 108 in the illustrated embodiment are substantially round, in which case they have a diameter d greater than or equal to 0.5 millimeters and smaller than or equal to 2 millimeters. As tests conducted by the inventors have shown it is thus possible with a sub-atmospheric pressure, which is applied to the chamber 78 in the housing 74, in a range between −60 and −90 kPa at the retaining section 76 of the rubber-elastic membrane 75 to generate holding forces which readily satisfy processing requirements usual in spectacle lens production.

It is additionally indicated in FIG. 6 by a dotted line that—and where—a semi-permeable membrane section 112, which covers the perforation 108 from the inside and in that case enables exchange of air via the perforation 108, but prevents penetration of liquid through the perforation 108 into the chamber 78, can be arranged on the inner side 81 of the retaining section 76 of the rubber-elastic membrane 75. If, for example, during processing in a generator 12 a spectacle lens 14 should on an occasion be lost from the retainer 10 then suction of cooling lubricant into the chamber 78 can be prevented by the semi-permeable membrane section 112.

According to, in particular, FIG. 9 the rubber-elastic membrane 75 has a bellows section 113 which radially outwardly adjoins the retaining section 76 and which in turn transitions into a thickened securing section 114 of the rubber-elastic membrane 75. The rubber-elastic membrane 75 is bound by the securing section 114 into an associated radial groove 115 of the base 83 of the housing 74, wherein a clamping band 116 mounted on the outer circumference of the securing section 114 keeps the securing section 114 in interlocking engagement with the radial groove 115 of the housing 74.

With respect to the rubber-elastic membrane 75 it is also to be said at this point that its resilient characteristics should in principle be selected so that the retaining section 76 of the rubber-elastic membrane 75 on the one hand is capable of equalizing the discrete points of the pin ends 80 of the pins 79 so that a continuous retaining surface for the spectacle lens 14 to be retained arises, but on the other hand should not be too soft, so as to not allow appreciable movement of the supported and held spectacle lens 14 on the retainer 10. As the tests conducted by the inventors have shown, the materials NBR (nitrile butadiene rubber) or EPDM (ethylene-propylene-diene; M group) are particularly suitable for construction of the rubber-elastic membrane 75, which should preferably have a hardness according Shore A of between 45 and 90. Moreover, the rubber-elastic membrane 75 should have in the retaining section 76 a material thickness greater than or equal to 1.0 and smaller than or equal to 2.5 millimeters.

Finally, details of the valve 107 associated with the chamber 78 in the housing 74 can also be inferred from FIGS. 9 and 12. The valve 107 can be selectively opened or closed so as in the opened state to apply a vacuum to the chamber 78 or in the closed state and with a spectacle lens 14 held at the retaining section 76 of the rubber-elastic membrane 75 by way of the perforation 108 to maintain the vacuum in the chamber 78.

Accordingly, the valve housing and the seat surfaces of the valve 107 are formed by the sealing flange 85 of the housing 74 of the retainer 10. A valve slide 119 provided with a handle 118 is movably arranged in a central passage bore 117 of the sealing flange 85 and is secured by a securing disc 120 against withdrawal. The valve slide 119 has two channel sections 121, 122 which extend along the center axis 94 and are separated from one another by a partition wall 123. One channel section 121, which is on the left in FIGS. 9 and 12, is connected with a source of sub-atmospheric pressure (not shown in the figures), whereas the other channel section 122 on the right in FIGS. 9 and 12 communicates with the chamber 78 in the housing 74. Transverse bores 124, 125 which each intersect a respective one of the channel sections 121, 122 are formed in the valve slide 119 near the partition wall 123. In addition, the passage bore 117 of the sealing flange 85 is enlarged in diameter in a middle region so that an annular space 126 is formed at the outer circumference of the valve slide 119 received in the passage bore 117. Finally, three seals 127 (O rings) with an axial spacing from one another are arranged at the outer circumference of the valve slide 119.

In the closed state of the valve 107, which is shown in FIG. 9, the seal 127 on the right in this figure separates the chamber 78 from the annular space 126 and the channel section 121 in the valve slide 119. A vacuum present in the chamber 78 can then be kept when the perforation 108 in the retaining section 76 of the rubber-elastic membrane 75 is closed by a spectacle lens 14 held at the retainer 10. On the other hand, in the opened state of the valve 107 illustrated in FIG. 12 the channel section 122—and thus the chamber 78—communicates by way of the transverse bores 125, the annular space 126 and the transverse bores 124, therefore past the partition wall 123 of the valve slide 119, with the channel section 121—and thus the sub-atmospheric pressure source.

It is apparent from the preceding description that the retainer 10 can adapt to the different surface topographies of spectacle lenses 14 to be held, wherein in the described embodiment the actual holding takes place by the holding arrangement 72 by way of generation of a vacuum between the spectacle lens 14 and the retainer 10. At the same time, a whole-area propping-up or support of the spectacle lens 14 at the workpiece surface 16 thereof is given by the pins 79, which bear against one another and which can be selectively fixed by the clamping mechanism 82 in a position once found, of the support arrangement 73. In that case, the rubber-elastic membrane 75, which by its retaining section 76 follows the adaptation of the pins 79 and is provided in the center with the perforation 108 of the holding arrangement 72 for application of the vacuum to the spectacle lens 14 and which prevents direct contact between the pins 79 and the spectacle lens 14, is disposed over the relief formed by the pins 79. As a consequence of the vacuum loading of the chamber 78, which is then sealed all round, in the housing 74 of the retainer 10 on the one hand the rubber-elastic membrane 75 firmly rests by the retaining section 76 thereof on the pin ends 80 and on the other hand the vacuum is also present, via the perforation 108 of the rubber-elastic membrane 75, in the region between the retaining section 76 and the resting workpiece surface 16 of the spectacle lens 14. The pressure of ambient air thus provides the holding force of the spectacle lens 14 on the retainer 10. Due to the fact that the membrane 75 in that regard is made of a rubber material, on the one hand good sealing of the intermediate space between the spectacle lens 14 and the membrane 75 relative to the environment is made possible and on the other hand a high co-efficient of friction is provided so that displacement of the spectacle lens 14 on the membrane 75 of the retainer 10 in succeeding processes is also prevented.

The following sequence is conceivable in the process of production of spectacle lenses 14: a) shape and position of the spectacle lens blank are determined by known methods (imaging station 68, measuring station 70); b) a handling unit (6-axis articulated arm robot 62) positions the spectacle lens blank, in correspondence with the computation specifications to hand, on the retainer 10 at the workpiece spindle 22 of the generator 12, wherein the positioning is carried out in such a way that all loaded pins 79 are plunged-in by a minimum value of, for example, 1 millimeter, whereby it is ensured that all pins 79 have contact by way of the retaining section 76 with the workpiece surface 16 of the spectacle lens 14; c) the clamping mechanism 82 of the pins 78 is actuated manually or automatically; d) the valve 107 is opened manually or automatically; e) vacuum is produced in the chamber 78 of the retainer 10 by way of the valve 107; f) the valve 107 is closed manually or automatically.

As a result, the spectacle lens 14 is disposed on the retainer 10 and is supported there over the whole area by the packet of pins 79 of the support arrangement 73 and held by way of the vacuum of the holding arrangement 72. As a consequence, all known processing steps of lens production can be performed, in which the workpiece surface 18 is processed, such as, for example, milling and turning processing (generating) in the generator 12. The same applies to, for example, polishing or marking on machines suitably equipped for that purpose. Ultimately, a process chain is supported without the necessity of a block piece or the process steps of “blocking” and “deblocking” connected therewith, as is described in the earlier German patent application DE 10 2021 004 831.8 of the same applicant.

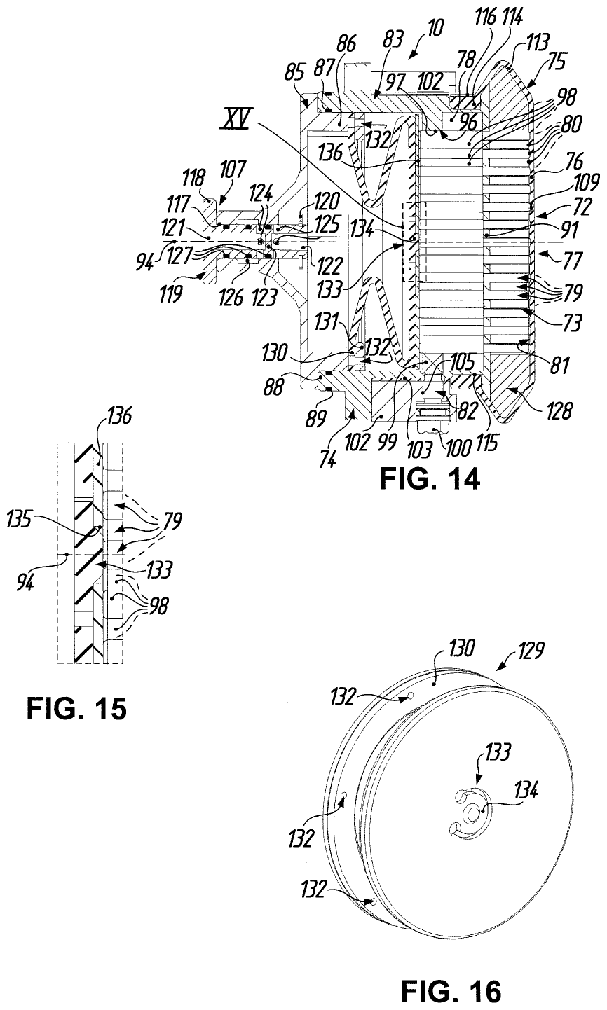

The second embodiment of the retainer 10 shall be briefly described in the following by way of FIGS. 14 to 16 only to the extent that it significantly differs from the above-described first embodiment, wherein the same or corresponding parts or subassemblies are denoted by the same reference numerals.

On the one hand, in the second example of embodiment according to FIG. 14 the rubber-elastic membrane 75 is supported radially outwardly of the pins 79, which bear against the retaining section 76, of the support arrangement 73 by at least one resiliently deformable shaped part, in the illustrated example a molded ring 128 of a foam material. Since the pins 79—as shown in FIG. 13—are also arranged in a hexagonal package in this embodiment and the covering rubber-elastic membrane 75 is circular, there is an irregular intermediate space between the pins 79 and the rubber-elastic membrane 75. This intermediate space is here filled with the shaped ring 128, which is adapted in terms of shape, as foam inlay so as to prevent undesired deformation of the rubber-elastic membrane 75 particularly in the region of the bellows section 113 when the vacuum is applied to the chamber 78.

On the other hand, in the second embodiment the spring bias of the pin 79 is solved differently from the first embodiment. According to FIG. 14, the pins 79 of the support arrangement 73 can be spring-biased, in particular, with the help of a pneumatic spring element 129 in the direction of the retaining section 76 of the rubber-elastic membrane 75. This pneumatic spring element 129 also is made of a rubber-elastic material and is illustrated separately in FIG. 16. In this embodiment the support flange 84 in the housing 74 is absent, as a comparison of FIGS. 9 and 14 shows. For that purpose the pneumatic spring element 129 is secured by its securing flange 130 by a clamping ring 131 in the housing 74, which at the reference numeral 132 is tightly screw-connected with the sealing flange 85 of the housing 74. The pneumatic spring element 129 can be acted on by way of the afore-described valve 107 with compressed air at a predetermined level so as to appropriately set the spring force to the respective requirements for pressing.

Such a “pneumatic spring” 129 which also is made of a rubber-elastic membrane—which is present under or behind the pins 79—and can be filled to a desired pressure by the feed of air, particularly has the advantage that the counter-pressure exerted on the pins 79 and thus on the workpiece surface 16, which is to be retained, of the spectacle lens 14 is settable and is independent of the plunging-in depth of the pins 79, by contrast with mechanical springs with a linear spring characteristic. Thus, regions of the spectacle lens 14 to be retained, which are urged deeper into the retainer 10, are acted on by the same force as regions which penetrate only very flatly.

Finally, it can also be seen in FIGS. 14 and 15 that the pneumatic spring element 129 has at a central point a flutter valve 133 which in the event of pressure-loading of the pneumatic spring element 129 closes for contact of the pins 79 of the support arrangement 73 with the retaining section 76 of the rubber-elastic membrane 75 and which opens in the event of vacuum-loading of the pneumatic spring element 129 so as to apply the vacuum to the chamber 78 bounded by the rubber-elastic membrane 75. For that purpose the flutter valve 133 has, in a manner known per se, a resiliently articulated valve flap 134 which co-operates with an opening 135 in a fixed valve seat plate 136, as shown in FIG. 15.

A retainer for processing optical workpieces each with two workpiece surfaces and a workpiece edge therebetween comprises a holding arrangement and a support arrangement for the workpiece. A resilient membrane mounted on a housing has in that case a retaining section, on the outer side of which the workpiece can be laid over an area by a workpiece surface. The membrane bounds together with the housing a chamber in which a plurality of separate longitudinally displaceable pins of the support arrangement is received. The latter can be brought by a respective pin end into contact with an inner side of the retaining section of the membrane and are selectively fixable relative to one another by a clamping mechanism against longitudinal displacement with respect to the housing so as to firmly support the retaining section in accordance with a geometry of the workpiece to be held by the holding arrangement. The holding arrangement for the workpiece is provided in or at the retaining section of the membrane and is capable of holding the workpiece without engaging the workpiece edge.

### REFERENCE NUMERAL LIST

10 retainer
12 generator (combined CNC milling/turning machine)
14 spectacle lens/workpiece
16 workpiece surface
18 workpiece surface
20 workpiece edge
22 workpiece spindle
24 turning processing unit
26 turning processing unit
28 fast-tool servo
30 fast-tool servo
32 turning tool
34 turning tool
36 milling processing unit
38 tool spindle
40 milling tool
42 adjusting mechanism
44 recess
46 upper side
48 machine frame
50 work space
52 measuring station
54 milling spindle
56 end mill
58 conveyor belt
60 job tray
62 6-axis articulated arm robot
63 flange surface
64 workpiece retaining head
66 workpiece turning device
68 imaging station
70 measuring station
72 holding arrangement
73 support arrangement
74 housing
75 rubber-elastic membrane
76 retaining section
77 outer side
78 chamber
79 pin
80 pin end
81 inner side
82 clamping mechanism
83 base
84 support flange
85 sealing flange
86 shoulder
87 sealing ring
88 securing section
89 sealing ring
90 end section
91 limiting plate
92 limiting plate
93 pin end
94 center axis
95 cylindrical pin
96 guide section
97 hexagonal opening
98 clamping region
99 force transmission element
100 set screw
101 cut-out
102 clamping plate
103 area seal
104 screw point
105 threaded bore
106 helical compression spring
107 valve
108 perforation
109 opening
110 inner pitch circle
111 outer pitch circle
112 semi-permeable membrane section
113 bellows section
114 securing section
115 radial groove
116 clamping band
117 passage bore
118 handle
119 valve slide
120 securing disc
121 channel section
122 channel section
123 partition wall
124 transverse bore
125 transverse bore
126 annular space
127 seal
128 shaped ring
129 pneumatic spring element
130 securing flange
131 clamping ring
132 screw connection or opening therefor
133 flutter valve
134 valve flap
135 opening
136 valve seating plate
d diameter of the openings of the perforation
A pivot axis (regulated in angular position)
B workpiece axis of rotation (regulated in angular position)
C tool axis of rotation (controlled in rotational speed)
D tool axis of rotation (controlled in rotational speed)
F1 linear axis of 1st fast-tool servo (regulated in position)
F2 linear axis of 2nd fast-tool servo (regulated in position)
Y linear axis of workpiece (regulated in position)

What is claimed is:

1. A retainer (10) for the processing of optical workpieces (14), which each have two workpiece surfaces (16, 18) and a workpiece edge (20) therebetween, comprising a holding arrangement (72) for a workpiece (14) to be processed as well as a support arrangement (73) therefor having a rubber-elastic membrane (75), which is mounted on a housing (74) and has a retaining section (76), on the outer side (77) of which the workpiece (14) can be laid over an area by one of the workpiece surfaces (16, 18) thereof, and which together with the housing (74) bounds a chamber (78) in which a plurality of separate longitudinally displaceable pins (79) of the support arrangement (73) is received, which pins can each be brought into contact with a pin end (80) at an inner side (81) of the retaining section (76) of the rubber-elastic membrane (75) and are selectively fixable to one another by a transversely acting clamping mechanism (82), or blockable by an axially acting blocking mechanism, against longitudinal displacement with respect to the housing (74) so as to firmly support the retaining section (76) in accordance with a geometry of the workpiece (14) held by the holding arrangement (72), characterized in that the holding arrangement (72) for the workpiece (14) to be processed is provided in or at the retaining section (76) of the rubber-elastic membrane (75) and is capable of holding the workpiece (14) without engaging the workpiece edge (20).

2. A retainer (10) according to claim 1, characterized in that a vacuum can be applied to the chamber (78) in the housing (74) and a perforation (108) as a component of the holding arrangement (72) is formed in the retaining section (76) of the rubber-elastic membrane (75) so that a vacuum applied to the chamber (78) is present by way of the perforation (108) on the outer side (77) of the retaining section (76) of the rubber-elastic membrane (75) for holding a workpiece (14) to be processed.

3. A retainer (10) according to claim 2, characterized in that the perforation (108) comprises a plurality of openings (109) in the retaining section (76) of the rubber-elastic membrane (75), the openings being distributed about a center axis (94) of the rubber-elastic membrane (75) preferably uniformly angularly spaced from one another on at least one pitch circle (110, 111).

4. A retainer (10) according to claim 3, characterized in that the openings (109) of the perforation (108) are substantially round and have a diameter (d) greater than or equal to 0.5 millimeters and smaller than or equal to 2 millimeters and/or the openings (109) of the perforation (108) are formed in a diameter area smaller than or equal to 40 millimeters with respect to the center axis (94) in the retaining section (76) of the rubber-elastic membrane (75) and/or the perforation (108) has between three and eighteen openings (109) distributed on two pitch circles (110, 111) and/or the sub-atmospheric pressure able to be applied to the chamber (78) lies in a range between −60 and −90 kPa.

5. A retainer (10) according to claim 4, characterized in that arranged on the inner side (81) of the retaining section (76) of the rubber-elastic membrane (75) is a semi-permeable membrane section (112) which covers the perforation (108) and in that case enables exchange of air via the perforation (108), but prevents passage of liquid through the perforation (108) into the chamber (78).

6. A retainer (10) according to claim 5, characterized in that associated with the chamber (78) is a valve (107) which is selectively openable or closable so as in the open state to apply a vacuum to the chamber (78) or in the closed state to maintain the vacuum in the chamber (78) when a workpiece (14) is held at the retaining section (76) of the rubber-elastic membrane (75) by way of the perforation (108).

7. A retainer (10) according to claim 6, characterized in that the pins (79) of the support arrangement (73) are spring-biased in the direction of the retaining section (76) of the rubber-elastic membrane (75).

8. A retainer (10) according to claim 7, characterized in
that a helical compression spring (106) is associated with each pin (79) of the support arrangement (73) so as to generate the spring-bias in the direction of the retaining section (76) of the rubber-elastic membrane (75) or
that the pins (79) of the support arrangement (73) are spring-biased in the direction of the retaining section (76) of the rubber-elastic membrane (75) with the help of at least one pneumatic spring element (129).

9. A retainer (10) according to claim 8, characterized in that the pneumatic spring element (129) comprises a flutter valve (133) which, when the pneumatic spring element (129) is acted on by pressure, closes for contact of the pins (79) of the support arrangement (73) with the retaining section (76) of the rubber-elastic membrane (75) and which, when the pneumatic spring element (129) is acted on by vacuum, opens so as to apply the vacuum to the chamber (78) bounded by the rubber-elastic membrane (75).

10. A retainer (10) according to claim 9, characterized in that the longitudinally displaceable pins (79) of the support arrangement (73) are arranged in the housing (74) in a substantially hexagonal package, for which purpose the housing (74) has a guide section (96) having as seen in cross-section a substantially hexagonal opening (97) through which the pins (79) extend and/or
that the longitudinally displaceable pins (79) of the support arrangement (73) are cylindrical pins each with an offset clamping region (98) of largest diameter for clamping by the clamping mechanism (82), wherein the pins (79) bear linearly against one another by the clamping regions (98) thereof and/or the clamping regions (98) of the pins (79) have an outer diameter between 2.5 and 4.5 millimeters and/or
that the longitudinally displaceable pins (79) of the support arrangement (73) extend by the pin ends (80) thereof through at least one apertured limiting plate (91) which limits longitudinal movement of the pins (79) in the housing (74).

11. A retainer (10) according to claim 10, characterized in that the clamping mechanism (82) comprises at least one force transmission element (99) by way of which a clamping force is transmissible to the pins (79), which force runs from a side of the housing (74) substantially in the direction of a center axis (94) of the housing (74) and acts perpendicularly to the longitudinal axes of the pins (79).

12. A retainer (10) according to claim 11, characterized in that the force transmission element (99) can be mechanically loaded with the clamping force by way of a least one set screw (100) mounted on the housing (74).

13. A retainer (10) according to claim 12, characterized in that the rubber-elastic membrane (75) is supported radially outwardly of the pins (79) of the support arrangement (73), which bear against the retaining section (76), by at least one resiliently deformable shaped part (128), particularly a shaped ring of foam material.

14. A retainer (10) according to claim 13, characterized in that the rubber-elastic membrane (75) is made of NBR or EPDM and/or has a hardness according to Shore A between 45 and 90 and/or a material thickness greater than or equal to 1.0 and smaller than or equal to 2.5 millimeters.

15. A retainer (10) according to claim 14, characterized in that the housing (74) has a securing section (88) for exchangeable securing to a workpiece spindle (22).

16. A retainer (10) according to claim 2, characterized in that arranged on the inner side (81) of the retaining section (76) of the rubber-elastic membrane (75) is a semi-permeable membrane section (112) which covers the perforation (108) and in that case enables exchange of air via the perforation (108), but prevents passage of liquid through the perforation (108) into the chamber (78).

17. A retainer (10) according to claim 2, characterized in that associated with the chamber (78) is a valve (107) which is selectively openable or closable so as in the open state to apply a vacuum to the chamber (78) or in the closed state to maintain the vacuum in the chamber (78) when a workpiece (14) is held at the retaining section (76) of the rubber-elastic membrane (75) by way of the perforation (108).

18. A retainer (10) according to claim 1, characterized in that the pins (79) of the support arrangement (73) are spring-biased in the direction of the retaining section (76) of the rubber-elastic membrane (75).

19. A retainer (10) according to claim 18, characterized in
that a helical compression spring (106) is associated with each pin (79) of the support arrangement (73) so as to generate the spring-bias in the direction of the retaining section (76) of the rubber-elastic membrane (75) or
that the pins (79) of the support arrangement (73) are spring-biased in the direction of the retaining section (76) of the rubber-elastic membrane (75) with the help of at least one pneumatic spring element (129).

20. A retainer (10) according to claim 19, characterized in that the pneumatic spring element (129) comprises a flutter valve (133) which, when the pneumatic spring element (129) is acted on by pressure, closes for contact of the pins (79) of the support arrangement (73) with the retaining section (76) of the rubber-elastic membrane (75) and which, when the pneumatic spring element (129) is acted on by vacuum, opens so as to apply the vacuum to the chamber (78) bounded by the rubber-elastic membrane (75).

21. A retainer (10) according to claim 1, characterized in that the longitudinally displaceable pins (79) of the support arrangement (73) are arranged in the housing (74) in a substantially hexagonal package, for which purpose the housing (74) has a guide section (96) having as seen in cross-section a substantially hexagonal opening (97) through which the pins (79) extend and/or
that the longitudinally displaceable pins (79) of the support arrangement (73) are cylindrical pins each with an offset clamping region (98) of largest diameter for clamping by the clamping mechanism (82), wherein the pins (79) bear linearly against one another by the clamping regions (98) thereof and/or the clamping regions (98) of the pins (79) have an outer diameter between 2.5 and 4.5 millimeters and/or
that the longitudinally displaceable pins (79) of the support arrangement (73) extend by the pin ends (80) thereof through at least one apertured limiting plate (91) which limits longitudinal movement of the pins (79) in the housing (74).

22. A retainer (10) according to claim 1, characterized in that the clamping mechanism (82) comprises at least one force transmission element (99) by way of which a clamping force is transmissible to the pins (79), which force runs from a side of the housing (74) substantially in the direction of a center axis (94) of the housing (74) and acts perpendicularly to the longitudinal axes of the pins (79).

23. A retainer (10) according to claim 22, characterized in that the force transmission element (99) can be mechanically loaded with the clamping force by way of a least one set screw (100) mounted on the housing (74).

24. A retainer (10) according to claim 1, characterized in that the rubber-elastic membrane (75) is supported radially outwardly of the pins (79) of the support arrangement (73), which bear against the retaining section (76), by at least one resiliently deformable shaped part (128), particularly a shaped ring of foam material.

25. A retainer (10) according to claim 1, characterized in that the rubber-elastic membrane (75) is made of NBR or EPDM and/or has a hardness according to Shore A between 45 and 90 and/or a material thickness greater than or equal to 1.0 and smaller than or equal to 2.5 millimeters.

26. A retainer (10) according to claim 1, characterized in that the housing (74) has a securing section (88) for exchangeable securing to a workpiece spindle (22).
